(19) United States
(12) Patent Application Publication
(10) Pub. No.: US 2005/0049980 A1
(43) Pub. Date: Mar. 3, 2005

(54) System for charging small amounts on online networks

(76) Inventor: Tomaz Volk, Ljubljana (SI)

Correspondence Address: CONNOLLY BOVE LODGE & HUTZ LLP, SUITE 800, 1990 M STREET NW, WASHINGTON, DC, 20036-3425, US

(21) Appl. No.: 10/474,810

(22) PCT Filed: Mar. 28, 2002
(86) PCT No.: PCT/SI02/00010

(30) Foreign Application Priority Data
Apr. 13, 2001 (SI) P-200100103

(51) Int. Cl. G06F 17/00

(52) U.S. Cl. 705/400; 700/1

(57) ABSTRACT

The invention relates to a system for charging small amounts of money on online networks. Hereinafter the invention will also be referred to as a “tariffer”. The invention may be employed in the field of online networks, such as the Internet, mobile wireless networks, telephone networks etc. In addition to charging as such the system of the invention also allows control and manipulation of the non-spoken content that is being transferred over the networks. For example, the system of the invention may be used to charge small amounts in the sale of content, information, products and services over networks.

The invention relates to a system for charging small amounts of money on online networks. Hereinafter the invention will also be referred to as a “tariffer”. The invention may be employed in the field of online networks, such as the Internet, mobile wireless networks, telephone networks etc. In addition to charging as such the system of the invention also allows control and manipulation of the non-spoken content that is being transferred over the networks. For example, the system of the invention may be used to charge small amounts in the sale of content, information, products and services over networks.

Several methods for charging the information acquired and the products and services purchased over online networks are known, none of which, however, as will be explained later on, are as useful and adequate for selling content, information, products and services as the system of the present invention. While the invention shall prevalently be described with reference to the Internet as an example of an online network, it can be, with slight modifications, utilized on any online network.

In online media, the following charging systems are conventionally known:

Credit Card Billing:

The customer enters his or her credit card number and personal information, whereupon the vendor bills the credit card and, if the transaction is authorized, delivers the requested information, product, or service to the customer.

Subscription to an Information Service:

The customer obtains a subscriber account from the information vendor and receives an identification password, such as a username and password. To access information, the customer must enter his or her username and password and will be charged a flat monthly fee by the vendor for using the service.

Pre-Paid Products:

The customer purchases a pre-paid code and enters it when wishing to acquire information from the information vendor. Each code contains a certain number of tokens which is decreased with every downloaded piece of information. When the tokens run out, the customer must purchase a new pre-paid code.

E-Cash Products:

A dedicated software is installed on the customer's computer and likewise a dedicated software is installed on the vendor's computer and interfaced to the software the vendor uses for selling information, products and services. Thereupon, the customer fills the account in the installed software and then draws from the account to buy information, products and services from the vendor.

Charging Services Using Transaction Monitors: The Internet service provider can install a dedicated software for monitoring data exchanged between the vendor and the customer, and can charge the customer for the transferred information.

Whilst generally useful for larger payments, the conventional solutions are far too complicated to be used for paying small or extremely small amounts. Consequently, as regards the payment of small amounts, the known solutions are hardly applied anywhere, and the low-priced information is mostly given out free of charge, while the vendor tries to produce revenue by placing advertisements on such pages.

The main disadvantages of the known art solutions are:

They are unrelated—for each vendor, a separate identification procedure must be performed by the customer, which is a very time-consuming task and may prove particularly inconvenient when purchasing low-priced information, selling at, say, 100 SIT. The customer must have multiple usernames and PPC codes, one for each information vendor, which is an encumbrance to the customer.

They require the vendor's software to be modified; the vendor must rewrite/enhance the software in order to start selling information, products, and services.

Certain solutions require dedicated software to be installed on the customer's side and filled to a certain amount, such additional efforts on the part of the client not being justified for small-amount purchases.

Flat rates deter customers, since the customer is expected to pay the average monthly fee, which is too expensive for the occasional visitor.

The existing transaction monitors only allow charging if the Internet service provider through which the vendor is accessed has the transaction monitor installed. If a customer should wish to access the vendor from another network, or to order a particular information, product or service for private purposes from the office computer, problems arise.

The object of the invention is to provide a system for charging small amounts on online networks which will overcome the drawbacks of the prior art and ensure a simple way of charging small amounts as well.

According to the invention, the object is fulfilled by a system for charging small amounts on online networks as set forth in the independent patent claims.

The invention is described with respect to charging information transferred over the Internet via the TCP/IP network. The system of the invention may likewise be used on any other network, such as WAP, GPRS, UMTS etc.

The drawings represent:

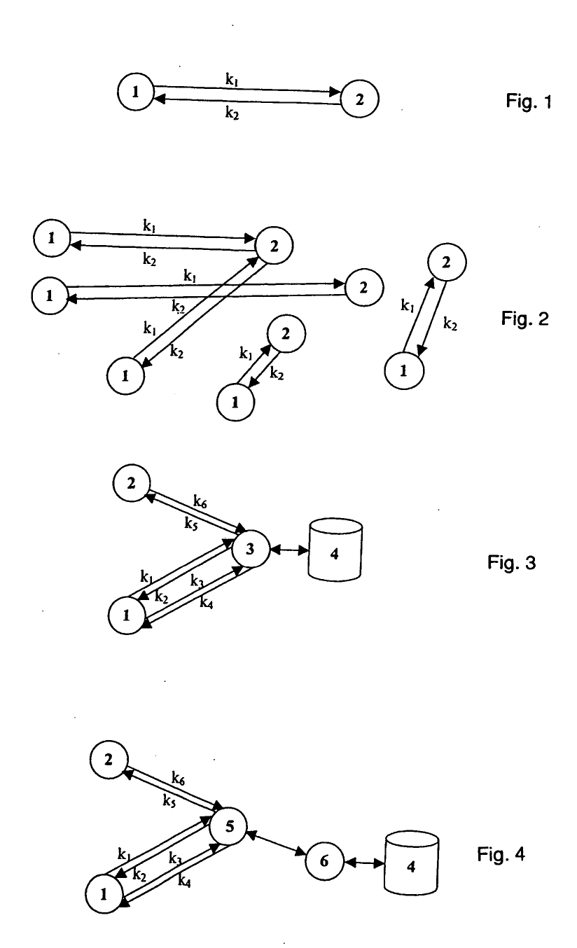

FIG. 1 Prior art direct connection between a single customer and a vendor,

FIG. 2 Prior art direct connections between multiple customers and vendors,

FIG. 3 A single connection between a customer and a vendor according to the invention, and

FIG. 4 An embodiment of the invention with a distributed tariffer.

As illustrated in FIG. 1, the customer, running a particular application (e. g. MS Internet Explorer), connects via TCP/IP to the computer of the vendor 2, running a WEB server software (e. g. MS IIS). The connection is established in such a way that the software programs of customer 1 and vendor 2, respectively, set up a bidirectional communication channel k1, k2. The customer's software sends requests for content in a specific format (say, HTML) to the vendor's computer. The vendor's server honors these requests, sending back content, formatted in a specific format (say, HTML, Java, . . . ), to the customer 1. The software on the customer's computer graphically represents the received information.

While FIG. 1 shows a connection between a single computer of the customer 1 and a single computer of the vendor 2, there are in fact many such computers, as may be seen in FIG. 2, every single computer having its unique address, TCP/IP number or URL. The customer's software has to “specify” the address of the server it is connecting to. The hyperlinks which are transferred to the customer 1 via the information pages of the vendor 2 are in fact new addresses, which the browser of the customer 1 then jumps to. In addition to the computer's address the customer's computer must also send the name of the page containing the desired content on the server of the vendor 2. The addresses are in the form of http://www.vendor.si/page1.html, where www.vendor.si is the address of the computer of the vendor 2, and page1.html is the name of the page on the computer of the vendor 2.

According to the invention, the identity of the customer has to be established, on the basis of which the mediator, i. e. the corporate body who is the operator-administrator of the system of the invention, will charge the customer and liquidate the payment to the vendor. In some cases, the identity of the customer may be established on the basis of his or her network address. For example, if the mediator is at the same time the Internet service provider, the identity may be derived from the Internet connection procedure already completed at logon; alternatively, when accessing the network via a cellular telephone, the telephone number could be used as customer identification.

Referring now to FIG. 3 of the invention, the customer connects not directly to the computer of the vendor 2, but to an intermediate computer—the tariffer 3. The tariffer 3 first proceeds to identify the customer I by exchanging information through the channels k1 and k2. If the identity can be determined automatically, this step is skipped. The tariffer 3 performs the identification by sending the customer 1 an extra page that enables identification. At this point, various means of identification might be typed in by the customer 1, such as:

his or her cellular telephone number—the vendor 2 administering the tariffer 3 responds by sending the password via SMS to the customer 1, who then enters it in the on-screen form;

his or her username and password; or

the pre-paid code.

Through the channel k3, the tariffer 3 receives the request for a particular content located at a particular address in the form of http://www.tariffer.si/ID=5, whereupon the tariffer 3 searches its database 4, retrieving the Internet address corresponding to ID=5 (say, http://www.vendor.si/page1.html); the tariffer 3 then forwards the request to the vendor 2 via the channel k5. The vendor responds by sending the content, i. e. the information requested by the customer 1, to the tariffer 3 through the channel k6. The tariffer 3 checks the credit situation of the customer 1 and in the case of a positive credit balance sends the information to the customer 1 via the channel k4. Besides the information as such, the tariffer 3 sends the customer an additional page containing essential information, such as current balance, current expenditures etc. After sending the information to the customer 1, the tariffer 3 registers the completed transaction into the database, said transaction constituting the primary information for making out the bill which will be sent by the mediator, i. e. the administrator of the tariffer to the customer 1, and also the primary information for liquidating the payment to the vendor 2.

Upon successful identification the tariffer 3 sends the customer a cookie, so that subsequent accesses to the tariffer 3 do not require the identification procedure to be repeated. The identification is only carried out once, even if the same customer 1 browses through diverse contents from different vendors, say, the weather forecast, the stock report, etc., via the tariffer 3.

As may be seen from the foregoing, the customer needs no additional software in order to use the system, an optional identification is all that is required, and it only has to be carried out once. The vendor 2 has to change the way the chargeable pages are accessed. The hyperlinks on the pages with free content must be modified to read as follows. Before:

<A HREF=www.vendor.si/page1.html>Weather Forecast</A>,

after:

<A HREF=www.tariffer.si/ID=5>Weather Forecast</A>.

At the same time, on the self-service pages of the tariffer, the vendor 2 maps ID=5 to the actual address and to the corresponding fee:

ID=5—www.vendor.si/page1.html—fee

Of course, the vendor 2 has to prevent direct access to the pages with chargeable content, since accesses that bypass the tariffer can't be charged for. This can be accomplished in various ways:

by preventing the pages to be accessed by any computer other than the tariffer;

by defining on the self-service pages a username and a password, used by the tariffer to access the chargeable pages; or

by “complicating” the page name, making it unguessable; since the page name is invisible to the customer, he or she will be able to access the page through the tariffer only.

FIG. 4 shows another way the system of the invention may be utilized. In this embodiment, the tariffer is split into two parts: a first tariffer 5, and a second tariffer 6. The tariffer 5 represents a simple device that is plugged into the network of the vendor 2 ahead of the vendor's server. On the network, the tariffer 5 is configured to the address www.vendor.si, and the computer of the customer 1 connects to the tariffer 5 over the network as if connecting to the server of the vendor 2. The tariffer 5 is connected to the tariffer 6 via the TCP/IP network. The communication now proceeds in the following manner:

The customer 1 connects to the address www.vendor.si, where now the tariffer 5 is located, which, connected to the tariffer 6 and its database 4 via a secure channel, proceeds to identify the customer 1. It forwards the information request, i. e. the order for a particular content, over the private network to the server of the vendor 2, the server of the vendor 2 responds, and if the credit situaton turns out to be positive upon verification by the tariffer 6, the tariffer 5 sends that information to the customer 1 as an additional screen, containing the account balance etc. The tariffer 5 then notifies the tariffer 6 over a secure channel about the concluded transaction. The tariffer 5 performs a very simple functionality, allowing a simple, inexpensive device to be developed which must be installed at the vendor 2. When the system is used this way, no address on the pages of the vendor 2 need be modified, only the address of the server has to be changed. Of course, the vendor 2 also has to set the fees for the individual pages on the self-service pages of the inventive system.

For large-scale utilization, the system of the invention may easily be distributed by installing multiple tariffers in information centers with concentrated traffic, the said tariffers exchanging information among themselves and operating as a unitary system. This holds for both above-described embodiments. The tariffer is also capable of operating in SSL secure mode. In this case, two separate secure channels are established—from the customer to the tariffer, and from the tariffer to the vendor 2, respectively.

The fees may be set in various ways; one is to set them on a per-page basis as described above, a further way is to set them dynamically by using a special command in HTML, such as <!-FEE=X SIT->, or they may be set in other ways, say, per unit of time, or based on a certain quantity, for example on the quantity of information, etc.

The system of the invention allows information, products and services to be charged in an effective way even when handling small amounts. The system has the following advantages:

The solution permits one universal system, connecting different vendors and different customers, to be used—the identification may be carried out automatically, or, where manual identification is required, it must only be performed once. The customers have access to the products through any Internet access provider, even though the Internet access provider in question has no tariffer installed.

No supplementary software must be installed on the vendor's side or on the customer's side.

The vendor may start charging for the content that already exists, by simply renaming the hyperlink addresses in accordance with the first embodiment, or by changing the address of the server according to the second embodiment, as specified hereinafter, which only represents about an hour's work, after which any preexistent content in the vendor's preexisting applications may immediately be charged for.

The customer only pays for the information, products and services actually delivered.

The separation of the charging and the Internet access providing functions enables the customer to be billed regardless of what kind of access he or she is currently using.

1. A system for charging small amounts on online networks, characterized in that there is a tariffer (3) between the customer (1) and the vendor (2).

2. A system according to claim 1, characterized in that the tariffer (3) is connected to the customer (1) and to the vendor (2) via bidirectional communication channels.

3. A system according to claim 1, characterized in that the tariffer (3) verifies the identity of the customer (1), retrieves the internet address from its database (4), forwards the request to the vendor (2), receives the content from the vendor (2), verifies the credit balance of the customer (1), sends the content to the customer (1) and registers the concluded transaction into the database (4).

4. A system for charging small amounts on online networks, characterized in that between the customer (1) and the vendor (2) there is a tariffer (5), to which a tariffer (6) is connected.

5. A system according to claim 4, characterized in that the tariffer (5) is connected to the customer (1) and to the vendor (2) via bidirectional communication channels.

6. A system according to claim 4, characterized in that the tariffer (5) is connected to the tariffer (6) via the network.

7. A system according to claim 4, characterized in that the tariffer (5), connected to the tariffer (6) via a secure channel, verifies the identity of the customer (1) and the credit balance of the customer (1), forwards the order to the server of the vendor (2), and notifies the tariffer (6) over a secure channel about the concluded transaction.
